(19) United States
(12) Patent Application Publication
(10) Pub. No.: US 2019/0320834 A1
(43) Pub. Date: Oct. 24, 2019

(54) MODULAR AUTOMATED LOCKER SYSTEMS FOR STORING AND DISPENSING CUSTOMER ORDERS

(71) Applicant: Walmart Apollo, LLC, Bentonville, AR (US)

(72) Inventors: David G. TOVEY, Rogers, AR (US); Todd MATTINGLY, Bentonville, AR (US); Bruce WILKINSON, Rogers, AR (US); Boyd D. BRYANT, Bella Vista, AR (US); Paul DURKEE, Centerton, AR (US)

(73) Assignee: Walmart Apollo, LLC, Bentonville, AR (US)

(21) Appl. No.: 16/391,612

(22) Filed: Apr. 23, 2019

Related U.S. Application Data
(60) Provisional application No. 62/661,130, filed on Apr. 23, 2018.

(51) Int. Cl. A47G 29/14; F24F 5/00; F24F 11/88; B64C 39/02; G06Q 10/08

(52) U.S. Cl. CPC A47G 29/141; F24F 5/0096; F24F 11/88; A47G 2029/142; G06Q 10/0832; A47G 2029/147; B64C 39/024

(57) ABSTRACT

A modular locker includes a bottom modular section. The bottom modular section includes a pickup window, a crane car and a crane associated with the crane car, a central computer and associated computer networking components, and a power unit. The locker system also includes at least one middle modular section. The at least one middle modular section is removably stacked atop the bottom modular, and includes a HVAC system, one or more doors, panels, shelves, and crane tracks. The locker system further includes a top modular section. The top modular section is removably stacked atop the at least one middle modular section, and includes a HVAC system, one or more doors, panels, shelves, and crane tracks.

### CROSS REFERENCE TO RELATED APPLICATION

This patent application claims the benefit of U.S. Provisional Application No. 62/661,130, filed on Apr. 23, 2018, content of which is incorporated by reference herein.

### BACKGROUND

### 1. Technical Field

The present disclosure relates to an automated locker that stores and dispenses customer orders. More specifically, the present disclosure relates to modular automated locker systems that store and dispense customer orders.

### 2. Introduction

An automated locker or kiosk that receives, stores, and dispenses customer orders, may be deployed at a desired location, by a retailer. As used herein, the “locker” and “kiosk” are interchangeable. Customers' orders may be loaded into the locker by store associates, carriers, and received into the locker via deliveries by unmanned aerial vehicles or drones. However, existing lockers are associated with some disadvantages. For example, package size of customer order is significantly restricted; capacity of a locker is fixed and not adjustable as desired; locker security is not sufficient; natural disaster tolerance is little considered for a locker; and a check-in feature that allows a locker to prepare in advance customer orders for quick pick-up is not integrated.

What is provided herein are modular automated locker systems for storing and dispensing customer orders, which may overcome some aspects of disadvantages of an existing locker.

### SUMMARY

Disclosed herein are modular locker systems for automated pickup of customer's parcels. The locker system may include a bottom modular section having infrastructure for mounting to a foundation, wherein the bottom modular section is configured to have a side circumferential vertical enclosure and a bottom horizontal surface connecting to the side circumferential vertical enclosure, and the bottom modular section includes a pickup window, a crane car and a crane associated with the crane car, a central computer and associated computer networking components, and a power unit. The locker system may also include at least one middle modular section having a side circumferential vertical enclosure and a bottom horizontal surface connecting to the side circumferential vertical enclosure of the at least one middle modular section, wherein the at least one middle modular section is removably stacked atop the bottom modular section such that the side circumferential vertical enclosure of the at least one middle modular section is structurally affixed, via the bottom horizontal surface connecting of the at least one middle modular section, to the side circumferential vertical enclosure of the bottom modular section, and wherein the at least one middle modular section includes a heating, ventilation, and air conditioning (HVAC) system, one or more doors in the bottom horizontal surface sealing around a central column of the modular locker system, panels, shelves, and crane tracks. The locker system may further include a top modular section having a side circumferential vertical enclosure, a bottom horizontal surface connecting to a bottom surface of the side circumferential vertical enclosure of the top modular section, and a top horizontal surface connecting to a top surface of the side circumferential vertical enclosure of the top modular section wherein the top modular section is removably stacked atop the at least one middle modular section such that the side circumferential vertical enclosure of the at least one middle modular section is structurally affixed, via the bottom horizontal surface connecting of the top modular section, to the side circumferential vertical enclosure of the top modular section, and wherein the top modular section includes a HVAC system, one or more doors in the bottom horizontal surface sealing around the central column of the modular locker system, panels, shelves, and crane tracks.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Embodiments of this disclosure are illustrated by way of an example and not limited in the figures of the accompanying drawings, in which like references indicate similar elements and in which:

FIG. 1 illustrates a perspective view of an example modular automated locker according to one example embodiment;

FIG. 2A illustrates a top view of a bottom modular section of the locker in FIG. 1 according to one example embodiment;

FIG. 2B illustrates a top view of a bottom modular section of the locker in FIG. 1 according to one example embodiment;

FIG. 2C illustrates a top view of a bottom modular section of the locker in FIG. 1 according to one example embodiment;

FIG. 3 illustrates an example multi-locker system according to one embodiment; and

FIG. 4 illustrates an example computer system which can be used to implement the systems and methods to one example embodiment.

### DETAILED DESCRIPTION

Various configurations and embodiments of the disclosure are described in detail below. While specific implementations are described, it should be understood that this is done for illustration purposes only. Other components and configurations may be used without parting from the spirit and scope of the disclosure.

In this disclosure, modular automated locker systems are provided. By varying a height of a locker, a capacity of the locker can be adapted to a local market, making deployment of the locker in a remote location, or a high-volume location more feasible. The height of the locker can be varied by extending the locker upwards or into the ground.

In some embodiments, top and bottom surfaces of the locker modules may utilize a standard connection for power and electricity, as well as standard connections for structurally coupling to each other.

In some embodiments, modular sections can be horizontal slices of the locker, where each section is stacked vertically. Modular sections can also be vertical wedge-shaped slices, where each section is stacked horizontally. In this disclosure, the primary consideration may be the former (i.e., vertical modularity). The angular- or wedge-shaped modular sections may be used as well, but are preferably used as sections on at ground level, where wedges may be swapped in and out of the sections. Those wedges may or may not be configured to have parcel portals, standard storage space, and remote delivery.

In some embodiments, a master (e.g., bottom) section may include a master power unit, a computer, etc. This master section may be only as large as required to contain all the components unique to the master section. The other functionality may be provided by the other modules.

In some embodiments, basic modular sections may have ambient product storage with no additional features. Additional sections may provide additional features to allow for a build-your-own locker feature. Such features may include modules with cold or frozen storage or heated storage.

In some embodiments, a crane is provided to store and retrieve items within the locker structure. The crane may move within the locker to specified locations to access items. The crane may be able to handle various heights by not specifying a location name (i.e., cubby), but rather specifying actual physical locations (e.g. 15′2″ up, and 45°). By using this method, the crane can identify parcel locations in lockers of different heights.

In some embodiments, an example modular section may be divided with respect to temperature: ambient, cool, or frozen. Modular sections may have a self-contained mechanical HVAC system. Modular sections in the locker may rely on a base section (e.g., a lowest modular section) for power and data only, not for the actual heating or cooling. The mechanical system may be entirely contained within the modular sections. The floors and ceilings of the modular sections may need to include doors that seal around a central column to keep the modular sections air tight, but allow for the crane to enter and leave to access items.

In some embodiments, power may alternatively be provided to each modular section individually. In this case, power may be provided to a number of modular sections, and not limited by the current carrying capacity of the base modular section and by the current carrying capacity of the wiring between modular sections. Power connections may be made by use of a male-female plug concept, which may follow a suitable industry standard.

In some embodiments, a top modular section may include a lighter structure than a base modular section, as it may only need to support its own weight. A master or base modular section may have a structure strong enough to support both itself and the stacked-on modular sections.

In some embodiments, the mechanical connections between modular sections may be standardized. For example, the mechanical connections may have interfitting features, and be secured with fasteners. The modular sections may be of different heights as needed. For example, a frozen items section may only need to be 5 feet high whereas general merchandise section may be 15 feet high.

In some embodiments, each modular section may be further divided into sub-modules, such as wedges. A master modular section (e.g., a bottom most modular section of the locker) may be generally the same as other modular sections, but may include a control system and portal for receiving and dispersing packages in a removable wedge sub-section. Each wedge may be swapped in and out of the locker conveniently.

An example modular automated locker system may comprise three types of modular sections. A bottom section may include unique componentry including infrastructure for mounting to foundation, pickup windows, a crane car, a central computer and associated networking components. The bottom section may be made of sturdier material in order to support the upper sections, as well as to provide protection against accidental ground level damage from carts, cars, children, etc. A center or middle section may include only panels, shelves, and crane track. The middle section may be made of lighter material. A top section may be similar to the middle section, but with a roof. This roof may include a drone landing site. There may also be communications components which are applied in the upper section. The modular sections may include standard connections for power, communications, etc. Also standard connections may be provided for structurally attaching the modular sections together.

Additionally, the modular sections may have sections for specific purposes. Special sections may be designed for hot, cold, large items, etc. For example, some stores may sell a large volume of dog food. Lockers at these locations may be provided with large slots, without the need to add another locker. An urban area with a lot of meal takeout may wish to add additional hot storage for hot meals. Many specially built modular sections can be provided according to this disclosure.

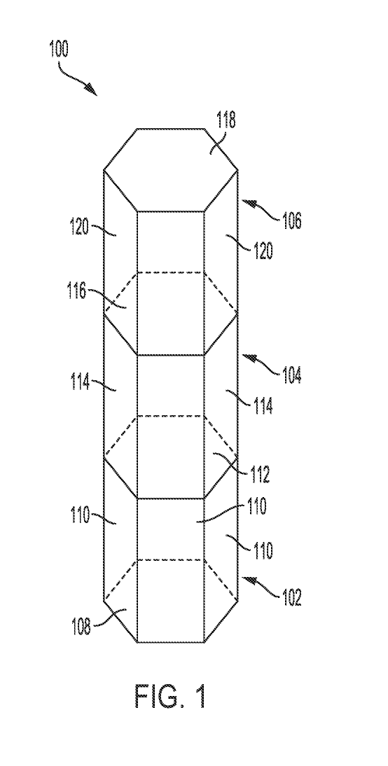

FIG. 1 illustrates an example modular locker 100. As shown in FIG. 1, the locker 100 may be a modular locker system for automated pickup of customer's parcels. The locker 100 may comprise a bottom modular section 102, at least one middle modular section 104, and a top modular section 106. The locker 100 may be installed in a remote location, or inside or outside a retail store. The bottom modular section 102, the at least one middle modular section 104, and the top modular section 106 can be vertically stacked on top of each other. Such locker configuration may allow capacity of the modular locker 100 to be adjustable based on a local market, such that deployment of the modular locker system is more feasible in a remote location, or at a high volume location. Such locker configuration may also allow for peak use and less climate control during off-peak use.

The bottom modular section 102 may be established at a ground level and may be configured to have infrastructure for mounting to a foundation. The bottom modular section 102 may further be configured to have a side circumferential vertical enclosure and a bottom horizontal surface 108 connecting to the side circumferential vertical enclosure. The side circumferential vertical enclosure may have a cross-section of any polygon, and may comprise a plurality of panels 110 corresponding to the sides of the polygonal cross-section. The bottom modular section 102 may also include one or more pickup or dispensing windows on the panels 110. The bottom modular section 102 may further include a crane car and a crane associated with the crane car, a central computer and associated computer networking components, and a power unit.

In some embodiments, the bottom modular section 102 may be made of sturdier materials in order to support the at least one middle modular section 104 and the top modular section 106, as well as to provide protection against accidental ground level damages.

In some embodiments, a height of the side circumferential vertical enclosure of the bottom modular section 102 may be determined based on heights of the crane car and the crane associated with the crane car, the central computer and associated computer networking components, and the power unit. The height of the bottom modular section 102 may also be only as tall as required to contain all the components unique to the bottom modular section 102.

In some embodiments, the bottom horizontal surface 108 of the bottom modular section 102 may be configured to have a standard connection for transferring power and electricity, as well as the infrastructure.

The at least one middle modular section 104 may be configured to have a side circumferential vertical enclosure and a bottom horizontal surface 112 connecting to the side circumferential vertical enclosure of the at least one middle modular section 104. The at least one middle modular section 104 may be vertically and removably stacked atop the bottom modular section 102, such that the side circumferential vertical enclosure of the at least one middle modular section 104 can be coordinately and structurally affixed, via the bottom horizontal surface 112 of the at least one middle modular section 104, to the side circumferential vertical enclosure of the bottom modular section 102. The at least one middle modular section 104 may include a self-contained mechanical heating, ventilation, and air conditioning (HVAC), one or more doors in the bottom horizontal surface 112 sealing around a central column of the modular locker system 100 to keep air tight. The bottom modular section 102 may also include a self-contained mechanical HVAC. The at least one middle modular section 104 may also include panels 114 that form the side circumferential vertical enclosure of the at least one middle modular section 104, shelves arranged inside the at least one middle modular section 104, and crane tracks that facilitate movements of the crane. The crane may be controlled by the central computer to move along crane tracks horizontally inside a modular section and vertically up across modular sections.

In some embodiments, the at least one middle modular section 104 may be made of lighter material and can be away from many ground level dangers. In some embodiments, the at least one middle modular section 104 may further include a pickup window in the side circumferential vertical enclosure for dispensing customer orders.

The top modular section 106 may be configured to have a side circumferential vertical enclosure, a bottom horizontal surface 116 connecting to a bottom surface of the side circumferential vertical enclosure of the top modular section 106, and a top horizontal surface 118 connecting to a top surface of the side circumferential vertical enclosure of the top modular section 106. The side circumferential vertical enclosure of the top modular section 106 may comprise a set of panels 120. The top modular section 106 may be vertically and removably stacked atop the at least one middle modular section 104, such that the side circumferential vertical enclosure of the at least one middle modular section 104 can be coordinately and structurally affixed, via the bottom horizontal surface 116 of the top modular section 106, to the side circumferential vertical enclosure of the top modular section 106. The top modular section 106 may also include a self-contained mechanical HVAC, one or more doors in the bottom horizontal surface 116 sealing around the central column of the modular locker system 100 to keep air tight. The top modular section 106 may further include shelves arranged inside the top modular section 106, and crane tracks that facilitate movements of the crane.

In some embodiments, the top horizontal surface 118 of the top modular section 106 may be configured to have a standard connection for transferring power and electricity. In some embodiments, the top modular section 106 may further include a drone or UAV landing site for package delivery. In some embodiments, the top modular section 106 may be formed of lighter structure than the bottom modular section 102, as it may only support its own weight, and none above.

In some embodiments, the bottom modular section 102, the at least one middle modular section 104, and the top modular section 106 may be basic sections that provide ambient-temperature product storage environment. In some embodiments, the bottom modular section 102, the at least one middle modular section 104, and the top modular section 106 may each include a self-contained mechanical HVAC. A temperature inside each of the bottom modular section 102, the at least one middle modular section 104, and the top modular section 106 may be one of the following: ambient, cool, or frozen. The HVAC of the bottom modular section 102, the at least one middle modular section 104, and the top modular section 106 may each be entirely contained within each corresponding modular section, respectively. In addition, the bottom modular section 102, the at least one middle modular section 104, and the top modular section 106 may be of different vertical heights partially based on each corresponding temperature. Each HVAC may rely on the bottom modular section 102 for power and data only, not for the actual refrigeration.

In some embodiments, the at least one middle modular section 104 and the top modular section 106 may receive power from the power unit of the bottom modular section 102 and may be in communication with the center computer of the bottom modular section 102. Power connections between the bottom modular section 102 and the at least one middle modular connection 104, and power connections between the top modular section 106 and the at least one middle modular connection 104 may be made by means of male-female plug connections, which can follow a suitable industry standard.

In some embodiments, power may alternatively be provided to each modular section individually. In this case, power can be provided to an indefinite number of modular sections, and not limited by the electric current carrying capacity of the bottom modular section 102, and the electric current carrying capacity of the wiring between the bottom modular section 102, the at least one middle modular section 104, and the top modular section 106. In this example embodiment, the bottom modular section 102, the at least one middle modular connection 104, and the top modular section 106, can each receive its respective power independently.

In some embodiments, structural connections between the bottom modular section 102 and the at least one middle modular connection 104, and structural connections between the top modular section 106 and the at least one middle modular connection 104 may be mechanical connections. The mechanical connections may be standardized, for example, to have interfitting features and be secured with fasteners. The bottom modular section 102, the at least one middle modular section 104, and the top modular section 106 may be of different heights as needed. For example, a modular section with a frozen temperature may only need to be 5 feet tall whereas general merchandise may need a modular section of 15 feet tall.

Each of the bottom modular section 102, the at least one middle modular section 104, and the top modular section 106 may be a single integral section, or may comprise a plurality of slices, for example, wedge-shaped slices.

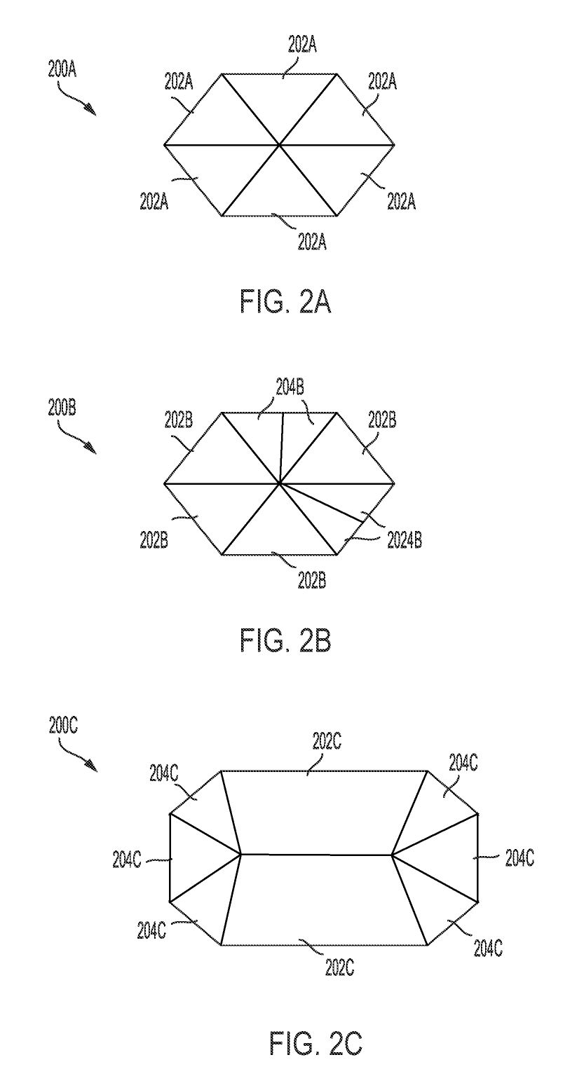

FIG. 2A illustrates a top view of a bottom modular section 200A of the locker 100 in FIG. 1 according to one example embodiment. As shown in FIG. 2A, the bottom modular section 200A may comprise a set of wedge-shaped slices 202A that may be removable from the bottom modular section 200A. The wedge-shaped slices 202A may be of equal dimensions. The wedges 202A may be swapped in and out for others with or without parcel portals or pickup windows, standard storage space, or remote delivery.

The central computer unit or control system, and the window for receiving and dispersing packages may be located in a removable wedge 202A. When one wedge is desired to be added to the bottom modular section 200A, the window and computer may first be removed from the bottom modular section 200A, to allow replacing with a wedge for normal product storage. The entire locker 100 may be lifted and replaced at the bottom with a similar slice. The door and computer may then be assembled to this new bottom section's open wedge.

FIG. 2B illustrates a top view of a bottom modular section 200B of the locker 100 in FIG. 1 according to one example embodiment. As shown in FIG. 2B, the bottom modular section 200B may comprise a plurality of wedge-shaped slices 202B and 204B of different sizes. The slices 204B may be formed by segmenting a larger size of slice 202B, which can allow for smaller segments in each slice 202B. The segmented slice 202B may hold two orders of customers—one on a right slice 204B and one on a left slice 204B. The segmented slice 202B may also hold one order, if the order is larger, using both slices 204B.

In a case where two orders are stored, one side of a double sliding door may open, allowing a customer to retrieve their order only. If it is one order using both slices 204B, both sliding doors may open, revealing the entire slice 202B for order retrieval.

In some embodiments, in addition to the segmented slices 204B, the slice 202B may further comprise levels, which can make the slice 202B partitionable into four quadrants or compartments. In such case, the door in the slice 202B may be two double doors. For example, to retrieve a small order in the lower right compartment of a slice 202B (e.g., the lower right compartment may be located in a right slice 204B of the slice 202B), the lower half of the door may open, and the right half of the second set of doors may also open, such that, together, the lower right compartment of the two-level slice 202B can be revealed.

FIG. 2C illustrates a top view of a bottom modular section 200C of the locker 100 in FIG. 1 according to one example embodiment. As shown in FIG. 2C, the bottom modular section 200C may comprise a set of slices of different shapes, for example, slices 202C of an irregular shape, and slices 204C of a triangle shape. Such configuration may allow for variable tray or compartment sizes for variable order sizes. Some sides of a locker can be larger with larger slices. This side may include a customer door, in order to deploy the larger trays. Large trays may not be able to exit the doors in smaller sides.

In some embodiments, an upper modular section or level may have pickup availability. In this case, wedge slices may be employed at an elevated level, and not limited to be at ground level.

Security systems disclosed herein may be applied to the above locker systems. The security systems can also be used for a locker system having a single modular section, for example, a locker system having only the bottom modular section 102. Further, the security systems may also be used for a locker system comprising a plurality of modular sections that are configured to be attached to one another horizontally, instead of being stacked vertically like the locker system 100 of FIG. 1.

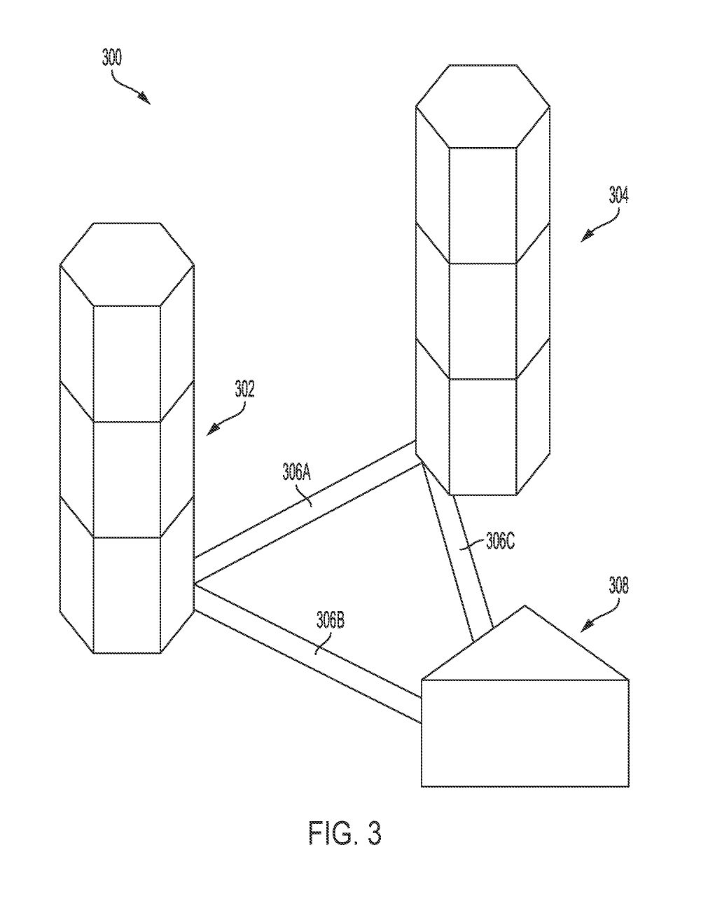

In some embodiments, a multi-locker or store system may be provided. FIG. 3 illustrates an example multi-locker/store system 300 that may implement the security system of FIG. 3 according to one embodiment. The system 300 may comprise a first automated locker 302, a second automated locker 304, and a store 308. The first automated locker 302, the second automated locker 304, and the store 308 may be physically and structurally connected to each other, for example, via connections 306A-C. The connection 306 may be an enclosed conveyor.

The first automated locker 302, when breached, may be configured to, via the central computer, transfer the packages from the first automated locker 302 to the second automated locker 304 through the enclosed conveyor 306 when at least one of the plurality of sensors inside the locker 302 is triggered, wherein the second automated locker 304 is not breached.

The first automated locker 302 or the second automated locker 304, when breached, may be configured to, via the central computer, transfer the packages from the automated lockers 302 and 304 to the store 308 through the enclosed conveyor 306 when at least one of the plurality of sensors is triggered.

In some embodiments, the connection 306 may comprise a track. The first automated locker 302 or the second automated locker 304, when breached, may be configured to move on the track to inside the store 308 and are protected by the store 308.

In some embodiments, the first automated locker 302 and the second automated locker 304 may further comprise an underground facility. The first automated locker 302 or the second automated locker 304, when breached, may be configured to automatically withdraw into the underground facility.

As described above, the automated locker may include a central computer in communication with the computing device. The automated locker may be configured to: receive, via the central computer, a check-in message of the customer from the computing device; receive, via the central computer, the location of the computing device; receive, via the central computer, a message indicative of the arrival of the customer at the automated locker, from the computing device; retrieve, via the central computer, information of the order from an order database stored on a remote server; assemble the order based on the check-in message and the information of the order; move the assembled order close to a pick-up location of the automated locker to facilitate pick-up of the assembled order.

The remote server in communication with the central computer may be configured to: store the information of the order in the order database; and send the information of the order to the central computer.

In some embodiments, the automated locker may further be configured to assemble the order based on the information regarding the locations of the order. In some embodiments, the automated locker may further be configured to assemble the order when the location of the computing device is within a predetermined distance from the automated locker. In some embodiments, the automated locker may be further configured to assemble the order when the message indicative of the arrival of the customer at the automated locker is received.

In some embodiments, the automated locker may be further configured to assemble the order in accordance with the general check-in time when the general check-in time does not interfere with confirmed check ins from other customers. The check-in time in the time range notified by the computing device may override the general check-in time.

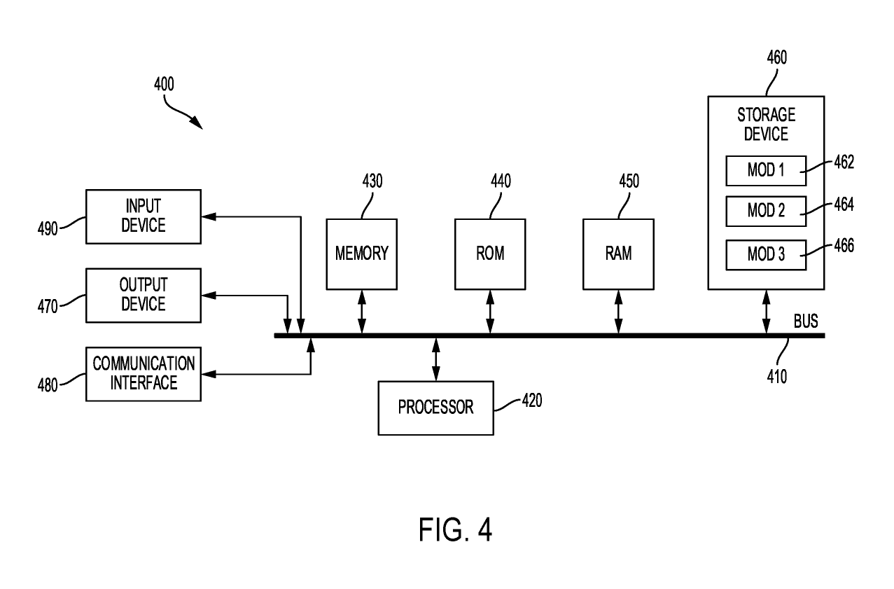

FIG. 4 illustrates an example computer system 400 which can be used to perform the systems for inventory monitoring as disclosed herein. The exemplary system 400 can include a processing unit (CPU or processor) 420 and a system bus 410 that couples various system components including the system memory 430 such as read only memory (ROM) 440 and random access memory (RAM) 450 to the processor 420. The system 400 can include a cache of high speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A modular locker system for automated pickup of customer's parcels, comprising:
a bottom modular section having infrastructure for mounting to a foundation, wherein the bottom modular section is configured to have a side circumferential vertical enclosure and a bottom horizontal surface connecting to the side circumferential vertical enclosure, and the bottom modular section includes a pickup window, a crane car and a crane associated with the crane car, a central computer and associated computer networking components, and a power unit;
at least one middle modular section having a side circumferential vertical enclosure and a bottom horizontal surface connecting to the side circumferential vertical enclosure of the at least one middle modular section, wherein the at least one middle modular section is vertically and removably stacked atop the bottom modular section such that the side circumferential vertical enclosure of the at least one middle modular section is structurally affixed, via the bottom horizontal surface connecting of the at least one middle modular section, to the side circumferential vertical enclosure of the bottom modular section, and wherein the at least one middle modular section includes a heating, ventilation, and air conditioning (HVAC) system, one or more doors in the bottom horizontal surface sealing around a central column of the modular locker system, panels, shelves, and crane tracks; and
a top modular section having a side circumferential vertical enclosure, a bottom horizontal surface connecting to a bottom surface of the side circumferential vertical enclosure of the top modular section, and a top horizontal surface connecting to a top surface of the side circumferential vertical enclosure of the top modular section wherein the top modular section is removably stacked atop the at least one middle modular section such that the side circumferential vertical enclosure of the at least one middle modular section is structurally affixed, via the bottom horizontal surface connecting of the top modular section, to the side circumferential vertical enclosure of the top modular section, and wherein the top modular section includes a HVAC system, one or more doors in the bottom horizontal surface sealing around the central column of the modular locker system to keep air tight, panels, shelves, and crane tracks.

2. The system of claim 1, wherein the modular locker system is installed inside or outside a retail store.

3. The system of claim 1, wherein capacity of the modular locker system is adjustable.

4. The system of claim 1, wherein the bottom modular section supports the at least one middle modular section and the top modular section.

5. The system of claim 1, wherein a height of the side circumferential vertical enclosure of the bottom modular section is determined based on heights of the crane car and the crane associated with the crane car, the central computer and associated computer networking components, and the power unit.

6. The system of claim 1, wherein the bottom horizontal surface of the bottom modular section is configured to have a standard connection for power.

7. The system of claim 1, wherein the top horizontal surface of the top modular section is configured to have a standard connection for power.

8. The system of claim 1, wherein the crane is configured to handle various heights inside the modular locker system to identify parcel locations.

9. The system of claim 1, wherein each of the bottom modular section, the at least one middle modular section, and the top modular section is adapted to store items at one of the following: ambient, cool, or frozen.

10. The system of claim 9, wherein the bottom modular section, the at least one middle modular section, and the top modular section are of different vertical heights.

11. The system of claim 1, wherein the HVAC of the at least one middle modular section and the HVAC of the top modular section is each entirely contained within the at least one middle modular section and the top modular section, respectively.

12. The system of claim 1, wherein the at least one middle modular section and the top modular section receive power from the power unit of the bottom modular section and are in communication with the center computer of the bottom modular section.

13. The system of claim 12, wherein power connections between the bottom modular section and the at least one middle modular connection, and power connections between the top modular section and the at least one middle modular connection are made by means of male-female plug connections.

14. The system of claim 1, wherein the bottom modular section, the at least one middle modular connection, and the top modular section, each receives its respective power independently.

15. The system of claim 1, wherein the at least one middle modular section is made of lighter material than the bottom modular section.

16. The system of claim 1, wherein structural connections between the bottom modular section and the at least one middle modular connection, and structural connections between the top modular section and the at least one middle modular connection are mechanical connections having interfitting features.

17. The system of claim 1, wherein the bottom modular section comprises a plurality of wedge-shaped slices, wherein each of the plurality of wedge-shaped slices is movable in or out of the bottom modular section.

18. The system of claim 17, wherein the central computer and the pickup window are located in one of the plurality of wedge-shaped slices.

19. The system of claim 1, wherein the top modular section further includes a drone landing site for parcel delivery.

20. The system of claim 1, wherein the at least one middle modular section further include a pickup window in the side circumferential vertical enclosure.
